(19) United States
(12) Patent Application Publication
(10) Pub. No.: US 2015/0186708 A1
(43) Pub. Date: Jul. 2, 2015

(54) BIOMETRIC IDENTIFICATION SYSTEM

(71) Applicant: Sagi Katz, Yokneam Ilit (IL)

(72) Inventor: Sagi Katz, Yokneam Ilit (IL)

(21) Appl. No.: 14/144,641

(22) Filed: Dec. 31, 2013

(51) Int. Cl. G06K 9/00

(52) U.S. Cl. CPC G06K 9/00087; G06K 9/00013; G06K 9/00208

(57) ABSTRACT

An embodiment of the invention provides a three dimensional biometric identification system (3D-BIS) comprising a head mounted 3D-range camera that acquires a 3D range image and a picture image of a biometric hand identifier of a wearer of the 3D range camera and uses the images to find a match with a biometric hand identifier associated with a person having a known identity to provide an identity for the wearer.

### TECHNICAL FIELD

Embodiments of the invention relate to methods and apparatus for identifying a person responsive to a biometric identifier associated with the person's hands.

### BACKGROUND

Biometrics refers to identifying or verifying persons by physical or behavioral traits, hereinafter also “biometric identifiers”, that are generally considered unique to an individual. Biometric identification refers to choosing an identity for a person from a plurality of possible identities of persons responsive to biometric identifiers acquired for each of the persons. Verification refers to determining if a person is who he or she claims to be responsive to a biometric identifier or identifiers acquired for the person. Unless otherwise explicitly noted or indicated by context, identifying is assumed to include verifying with any modifications as may be required, and an identification system is assumed to include a verification system.

Behavioral traits that are considered unique to an individual and may be used as biometric identifiers to identify the individual are by way of example: the individual's typing speed; his or her manner of speech, for example, word usage; spectrum, cadence, or accent of the individual's voice; and gait. Physical traits that are considered unique to an individual and may be used as biometric identifiers to identify an individual are fingerprints, retinal vasculature, texture of the iris, hand structure, hand vasculature, DNA, and of course the trait in most common use for identifying an individual—a person's face.

A biometric identification system that uses biometric identifiers to identify persons generally comprises a sensor that “captures” a biometric identifier of a person and a biometric database comprising data that may be used for associating the captured biometric identifier with a particular person. A processor processes the captured biometric identifier responsive to data in the biometric database to identify a particular person from whom the captured biometric identifier was acquired.

Capturing a biometric identifier comprises acquiring data generally considered sufficient to uniquely characterize the biometric identifier and may be referred to as acquiring an image of, or imaging a biometric identifier. Data acquired by imaging a biometric identifier of a person may be referred to as a “biometric image” of the biometric identifier or of the person. Imaging a biometric identifier may comprise for example, acquiring an image of a person or a portion of the person's body, acquiring a substance from, or produced by, the person's body, or acquiring a recording of a behavior pattern of the person.

Data in the biometric database comprises data, hereinafter also referred to as a “biometric template”, which may be used to classify the biometric image as acquired from, or not acquired from, a particular person. A biometric template corresponding to a given biometric identifier used to identify a person usually comprises a set of values, hereinafter also referred to as a set of “biometric template values”, for a set of features, which may be referred to as “biometric template features”, of the given biometric identifier. The biometric template features are chosen so that values associated with or descriptive of the biometric template features that may be extracted from biometric images of persons differ sufficiently from person to person so that the values may be used to identify persons from whom the biometric images are acquired. Values extracted for biometric template features from a biometric image of a person may hereinafter be referred to as “biometric image values”. The processor that processes biometric images to associate a biometric image of a biometric identifier with a particular person generally processes the image to extract a set of biometric image values from the image. The processor identifies a person from whom the biometric image was acquired by determining, using any of various methods known in the art, a set of biometric template values that most closely matches the biometric image values. The identity of the person is determined to be that of a person associated with the biometric template values that most closely match the biometric image values.

Biometric identification systems are coming into increasing use to control access to restricted resources, such as databases, virtual venues, and physical venues that are considered to require restricted access. Databases considered to require restricted access, may by way of example, be databases comprising personal medical or financial data, enterprise agreements or records, and intelligence or military data. Restricted access virtual venues may for example be any of various websites, such as bank and government service web sites, that provide confidential services to members of the public. Physical venues that may require restricted access may for example be electric power, gas, and water infrastructure facilities, military facilities, warehouses, and manufacturing plants. It appears that with improvement in biometric systems and reductions in their costs, use of biometrics to authenticate and allow access to restricted resources will replace use of tokens and code words.

### SUMMARY

An aspect of an embodiment of the invention relates to providing a relatively robust biometric identification system comprising a three dimensional (3D) range camera system that acquires a 3D range image of a biometric identifier of a person and uses the 3D range image to identify the person. Hereinafter, a biometric identification system in accordance with an embodiment of the invention may be referred to as a 3D biometric identification system (3D-BIS).

In an embodiment, the 3D range camera system is configured to acquire in addition to a 3D range image of the person's biometric identifier a contrast image, hereinafter also referred to as a “picture image” or “picture” of the person's biometric identifier. The 3D range image provides 3D spatial coordinates for features of the biometric identifier. The picture image provides pictures that may be used to identify the features of the biometric identifier. The 3D-BIS comprises a computer or computer system, hereinafter generically referred to as a computer, that processes the range and picture images to determine which distances in the range image are associated with which features of the biometric identifier. The features and their associated 3D spatial coordinates provide a “3D biometric image” of the biometric identifier for the person in which imaged features of the biometric identifier are located by 3D spatial coordinates.

The 3D-BIS comprises or has access to a biometric database containing 3D biometric templates for persons enrolled with the 3D-BIS. The 3D-BIS processes the 3D biometric image and 3D biometric templates to determine which of the 3D biometric templates contained in the biometric database most closely matches the 3D biometric image. The 3D-BIS determines the identity of the person to be the identity of an enrollee associated with the matching 3D biometric template. For scenarios in which a 3D-BIS verifies if the person is who he or she claims to be, the 3D-BIS determines if the 3D biometric image is considered to match a 3D biometric template in the database of the person he or she claims to be.

In an embodiment of the invention, a 3D biometric template for a given person enrolled with the 3D-BIS comprises 3D biometric template values for a biometric identifier of the given person. A 3D biometric template value of a biometric identifier may be a designation of a feature of the biometric identifier or an attribute of the feature, associated with 3D spatial coordinates that define a location of the feature. Alternatively or additionally, the 3D biometric template value may be an attribute of the biometric identifier derived from a plurality of features of the biometric identifier responsive to their 3D spatial coordinates. Processing the 3D biometric image and 3D biometric templates to match the biometric image to a 3D biometric template comprises extracting 3D biometric image values from the 3D biometric image and comparing the extracted values to 3D biometric template values of 3D biometric templates contained in the biometric database. Similar to 3D biometric template values, a 3D biometric image value extracted from a 3D biometric image may be a designation of feature of the 3D biometric image or an attribute of the feature, associated with 3D spatial coordinates that define a location of the feature in the 3D biometric image. Alternatively or additionally, the 3D biometric image value may be an attribute of the 3D biometric image derived from a plurality of features of the 3D biometric image responsive to their 3D spatial coordinates.

Because the processing to find a match in accordance with an embodiment of the invention, is performed with 3D biometric image and 3D biometric template values that are associated with 3D spatial coordinates, the processing is relatively immune to orientation of the biometric identifier in a field of view (FOV) of the 3D camera system that acquires the 3D biometric image.

In an embodiment of the invention, the biometric identifier is associated with physical traits of the person's hand and may be referred to as a biometric hand identifier. Optionally, the biometric hand identifier comprises features of structure of the dorsal (back) and/or palmar (palm) side of the hand, and the 3D biometric image comprises a range image of the dorsal and/or palmar side of the hand and a corresponding picture image of the dorsal and/or palmar side of the hand. In an embodiment of the invention, the biometric identifier comprises the vasculature of the hand and the 3D biometric image comprises a range image and picture image of the vasculature of the hand. Optionally, the biometric identifier comprises the vasculature in the dorsal side of the hand.

In an embodiment of the invention, the 3D-BIS comprises a head worn support to which the 3D range camera that acquires 3D biometric images of the person's hand is mounted. The 3D range camera mounted to the head worn support may be oriented so that the 3D range camera's FOV includes a region of space in which the hands of a person wearing the head mounted support are typically present when being used to perform a manual operation, such as operate a keyboard or tablet computer, write a note, or play cards. If the 3D-BIS identifies the person responsive to a 3D biometric image of the person's hand provided by the 3D range camera as a person authorized to use a given restricted resource, the 3D-BIS may notify the given resource to allow the person access and use of the resource.

Optionally, the head worn support comprises or is part of a head mounted display (HMD) or an augmented reality (AR) apparatus, such as AR glasses, configured to provide a person wearing the HMD or AR apparatus with a virtual reality, or an augmented reality display that overlays or replaces a portion of the person's FOV. Unless otherwise explicitly indicated or indicated by context, reference to an AR apparatus or AR glasses refers generically to any apparatus capable of providing a virtual or augmented reality.

If the 3D-BIS identifies the person as a person authorized to use the AR apparatus, the AR apparatus may provide the person with a virtual interactive display with which the person may interact. The display may for example comprise a virtual keyboard or an eBook. The person may use hand gestures that are recognized by the 3D-BIS computer responsive to processing images of the hand gestures acquired by the 3D-range camera to use the virtual keyboard or turn pages in the eBook.

A 3D-BIS in accordance with an embodiment of the invention may comprise a 3D range camera mounted to or in a vicinity of any non-wearable apparatus to acquire 3D range and picture images of a person's hands and authorize use of the apparatus by the person responsive to the images.

In the discussion, unless otherwise stated, adverbs such as “substantially” and “about” modifying a condition or relationship characteristic of a feature or features of an embodiment of the invention, are understood to mean that the condition or characteristic is defined to within tolerances that are acceptable for operation of the embodiment for an application for which it is intended. Unless otherwise indicated, the word “or” in the specification and claims is considered to be the inclusive “or” rather than the exclusive or, and indicates at least one of, or any combination of items it conjoins.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical features that appear in more than one figure are generally labeled with a same numeral in all the figures in which they appear. A label labeling an icon representing a given feature of an embodiment of the invention in a figure may be used to reference the given feature. Dimensions of components and features shown in the figures are chosen for convenience and clarity of presentation and are not necessarily shown to scale.

FIG. 1 schematically show a 3D-BIS comprising a 3D range camera mounted on AR glasses worn by a person, in accordance with an embodiment of the invention;

FIG. 2A schematically shows the 3D range camera acquiring 3D biometric images of the person's hands for use by 3D-BIS to identify the person wearing the 3D-BIS, in accordance with an embodiment of the invention;

FIG. 2B schematically show a picture image of the vasculature of the person's right hand acquired by the 3D range camera for a first orientation of the hand in the FOV of the 3D range camera, in accordance with an embodiment of the invention;

FIG. 2C schematically shows a picture image of the vasculature of the person's right hand acquired by the 3D range camera for a second orientation of the hand in the FOV of the 3D range camera, in accordance with an embodiment of the invention;

FIG. 3 schematically shows the 3D-BIS shown in FIG. 2B providing the person wearing the AR glasses with a virtual keyboard for use by the person after having identified the person, in accordance with an embodiment of the invention; and

FIG. 4 schematically shows an automatic teller machine (ATM) comprising a 3D-BIS identifying a person using the ATM in accordance with an embodiment of the invention.

### DETAILED DESCRIPTION

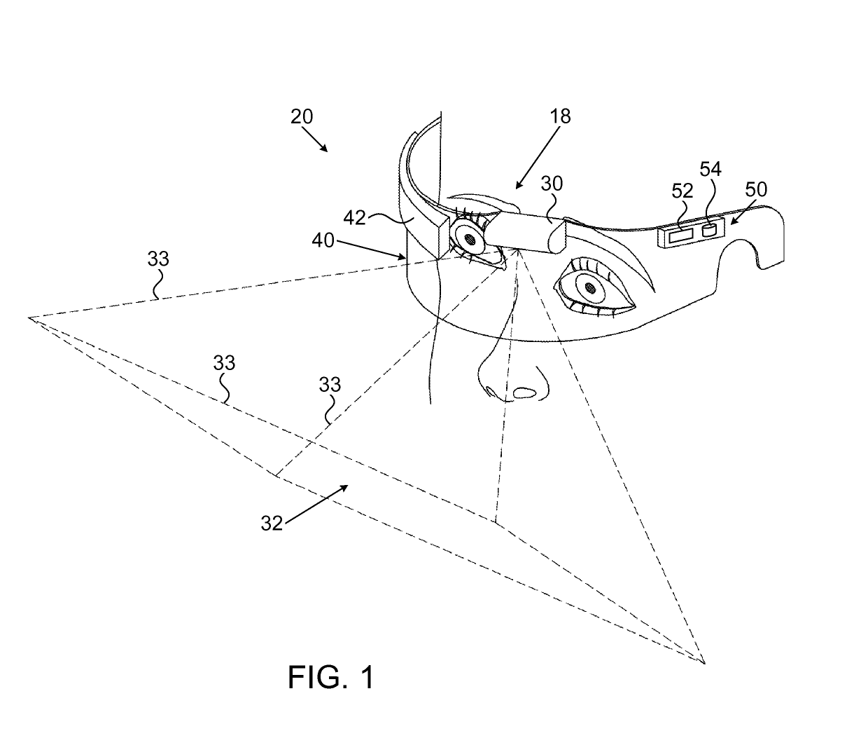

FIG. 1 schematically shows a head mounted 3D-BIS 20 worn by a person 18, in accordance with an embodiment of the invention. 3D-BIS 20 operates to identify a person responsive to 3D biometric images of a biometric identifier that a 3D range camera 30 comprised in 3D-BIS 20 acquires, optionally for person 18 wearing the 3D-BIS. 3D range camera 30 is optionally mounted to AR glasses 40 having an AR system 42, comprising an AR camera, AR display and an AR controller, which are not shown separately in FIG. 1. AR system 42 may be any of various AR systems that use an AR camera to image a person's surrounding environment, integrate it with an overlay of digital information and/or virtual objects to generate an augmented image, and display the augmented image to the person. Displaying the augmented image may be effected by displaying the overlay on a see-through graphics display or projecting the augmented image onto the person's retina using a retinal projector. A computer 50 optionally mounted to AR glasses 40 processes 3D biometric images acquired by 3D range camera 30 to identify persons from whom the 3D biometric images are acquired. Computer 50 optionally controls 3D range camera 30 and may function as the AR controller.

In an embodiment of the invention, 3D-BIS 20 acquires and processes a 3D biometric image of a biometric hand identifier associated with a hand of person 18 to determine an identity for the person. 3D range camera 30 is configured to image a hand or hands of person 18 to acquire 3D biometric image of the biometric hand identifier. Computer 50 is configured to process the 3D biometric image to determine the identity of person 18 and comprises a processor 52 and optionally a biometric database 54 optionally stored in a memory comprised in computer 50. Biometric database 54 comprises 3D biometric template values for a 3D biometric template of the biometric identifier for each of one or more persons enrolled with 3D-BIS 20. Computer 50 determines the identity of person 18 responsive to the 3D biometric image acquired by 3D range camera 30 of the hand of person 18 and biometric template values comprised in the 3D biometric template for each of the one or more enrollees of 3D-BIS 20.

In an embodiment of the invention, person 18 may have to look in the direction of his or her hands to bring the hands into the FOV of 3D range camera 30 so that 3D range camera 30 can image the hands. Optionally as schematically shown in FIG. 1, 3D range camera 30 has a relatively large FOV 32 outlined with dashed lines 33 so that it may image the hands of person 18 in various positions around the person's body without the person having to look directly at his or her hands. The FOV may for example have a vertical view angle equal to or greater than about 120° in a plane that extends perpendicular to the ground and a horizontal view angle in a plane parallel to the ground greater than or equal to about 80°. To provide the large FOV, 3D range camera 30 may be a compound 3D range camera comprising two or more component 3D range cameras whose respective FOVs combine to provide the large FOV.

Optionally, 3D-BIS 20 initiates acquisition and processing of a 3D biometric image to identify person 18 responsive to an image of a predetermined hand gesture performed by person 18 in the FOV of 3D range camera 30. For example upon person 18 donning 3D-BIS 20, computer 50 may control 3D range camera 30 to repeatedly acquire images of objects and features in its FOV, which computer 50 processes to determine if the hand gesture is performed. If the hand gesture is performed computer 50 initiates acquisition and processing of a 3D biometric image to identify person 18. In an embodiment of the invention the predetermined hand gesture may be clenching the hand to make a fist with the dorsal side of the hand facing 3D range camera 30.

3D range camera 30 may be any of various 3D range cameras that are configured to acquire a picture of a scene as well as a range image of the scene. In an embodiment, 3D range camera 30 may be an active illumination 3D range camera that projects light onto a scene that it images. The 3D range camera 30 provides distances to features of the scene responsive to light from the projected light that the features reflect back to the 3D range camera, which 3D range camera 30 registers on pixels of its photosensor (not shown). The 3D active illumination range camera may be a triangulation 3D range camera that illuminates a scene with structured light and uses image disparity to provide distances to features in the scene. In an embodiment of the invention, 3D range camera 30 is a time of flight (TOF) 3D range camera that illuminates a scene with pulses of light and provides distances to features in the scene responsive to time it takes light in the pulses to make a round trip from the TOF-3D range camera to the features and back to the TOF-3D range camera. An amount of light registered on a given pixel of the TOF-3D range camera 30 may be used in accordance with any of various methods known in the art to determine a distance from the camera to a feature imaged on the given pixel. For convenience of presentation, in the discussion that follows it is assumed that 3D-range camera 30 is a TOF 3D range camera.

In an embodiment of the invention, the at least one biometric identifier that 3D-BIS 20 uses to identify person 18 comprises dorsal vasculature of the person's hand or hands. Optionally, light that 3D range camera 30 transmits to illuminate a scene that it images comprises light at wavelengths that are preferentially absorbed or reflected by blood vessels and provide contrast between the blood vessels and surrounding tissue in the back of the hands. Infrared (IR) light in a wavelength band between about 700 nm (nanometers) and about 1200 nm is preferentially absorbed by blood vessels relative to surrounding tissue and may be advantageous for imaging dorsal blood vessels in the hands of person 18.

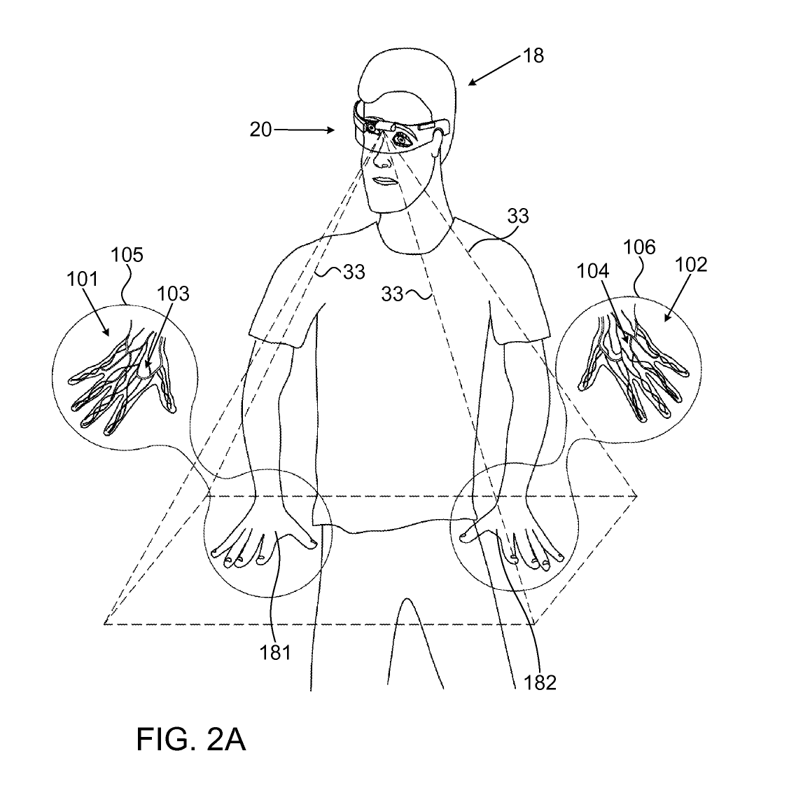

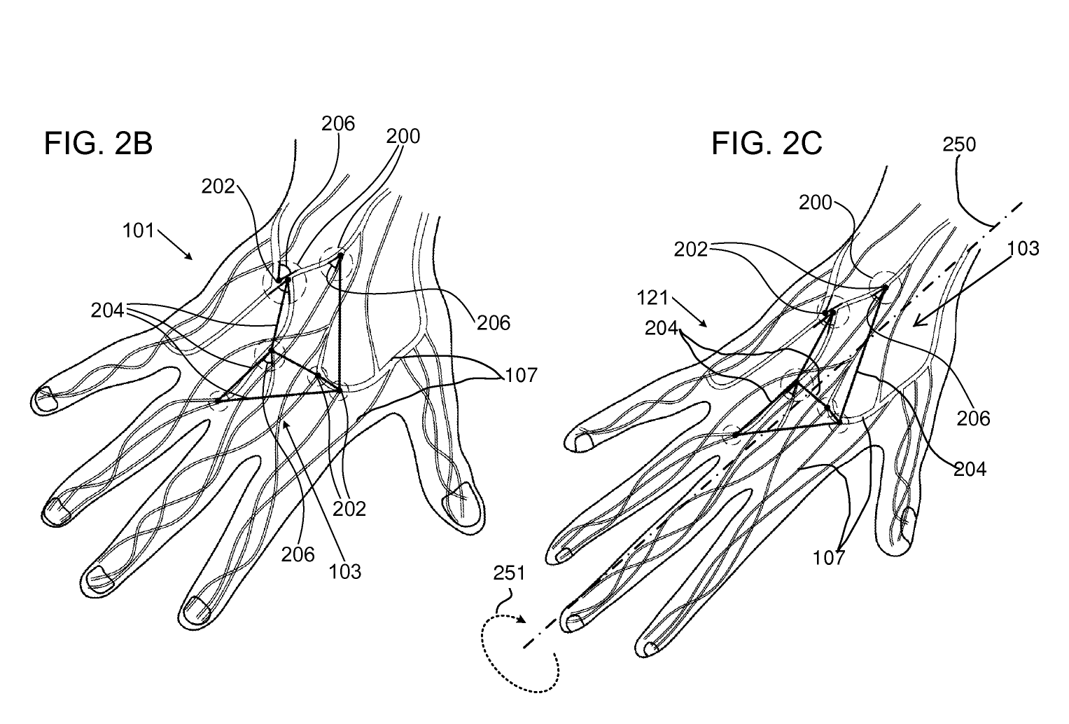

FIG. 2A schematically shows 3D range camera 30 imaging right and left hands 181 and 182 of person 18 that are located in a portion of FOV 32 (FIG. 1) of the 3D range camera indicated by dashed lines 33, to acquire 3D biometric hand images of the vasculature of the hands. Biometric picture (contrast) images 101 and 102 of right and left hands 181 and 182 acquired by 3D range camera 30 are schematically shown in insets 105 and 106 respectively. Biometric picture images 101 and 102 exhibit vasculature patterns 103 and 104 respectively contrasted against surrounding tissue in hands 101 and 102.

Processor 52 of computer 50 processes at least one of biometric picture images 101 and 102 to identify biometric image features in vasculature patterns 103 and 104 and associate the features with 3D spatial coordinates provided by 3D range images (not shown) of the vasculature provided by 3D range camera 30. Image features in the vasculature such as blood vessels and blood vessel branching points may be identified using any of various feature detection algorithms such as algorithms for detecting edges, ridges, corners, blobs that are well known in the art. Particular algorithms for detecting features that also provide descriptors for detected features are SIFT (Scale Invariant Feature Transform), HOG (Histogram of Oriented Gradients), and SURF (Speeded Up Robust Features).

Under the assumption that 3D range camera 30 is a TOF 3D range camera the association of identified features with 3D spatial coordinates is relatively straightforward. In some embodiments, TOF 3D range camera 30 acquires both a range image and a picture of a scene on a same photosensor of the 3D range camera. A feature imaged in the picture of the scene on a given pixel of the photosensor is associated with a range to the feature determined from light registered in the range image on the same given pixel. In some embodiments 3D range camera 30 acquires a 3D range image on a first photosensor and a picture image on a second photosensor aligned with the first photosensor so that homologous pixels image a same feature.

The association of the biometric image features identified by processor 52 in biometric picture images 101 and 102 with distances provided by the 3D range images generates 3D biometric hand images for hands 181 and 182. To distinguish between biometric picture images 101 and 102 and their corresponding 3D biometric hand images, which are not shown, the corresponding 3D biometric hand images are referred to as 3D biometric hand images 101 * and 102* respectively.

3D biometric image features of vasculature patterns 103 and 104 that are identified in biometric picture images 101 and 102 by 3D-BIS 20 comprise features that may be advantageous for use in determining which 3D biometric template stored in biometric database 54 most closely matches 3D biometric hand image 101* or 102*. The features may be used for example to “extract” 3D biometric image values from 3D biometric hand images 101* and 102* for comparison with 3D biometric template values comprised in 3D biometric templates stored for enrollees of 3D-BIS 20 in biometric database 54 to determine a match.

FIG. 2B shows an enlarged image of biometric picture image 101 in which blood vessels 107 and features of vasculature 103 of hand 181 that may be identified by 3D-BIS 20 for use in providing 3D biometric image values to identify person 18 are more clearly seen. By way of example, features that 3D-BIS 20 may identify are optionally blood vessel branching points indicated in FIG. 2B by filled circles 202. In an embodiment of the invention, 3D biometric image values associated with identified blood vessel branching points 202 are determined responsive to the 3D spatial coordinates that are associated with the blood vessel branching points in the 3D biometric hand image 101* of hand 181. The 3D biometric image values may comprise concentration of blood vessel branching points 202 per unit area of the back of hand 181 and/or distances between blood vessel branching points. Distances between the blood vessel branching points 202 are schematically indicated by straight lines 204 between the blood vessel branching points. Optionally, the 3D biometric values comprise angles, indicated by arcs labeled 206, between two blood vessels 107 at a blood vessel branching point 202. Because the 3D biometric image values are determined from the 3D spatial coordinates of the branching points the values are substantially independent of orientation of hand 181 at a time at which biometric picture image 101 and the corresponding 3D biometric hand image 101* are acquired.

FIG. 2C schematically shows a biometric picture image 121 of vasculature 103 of hand 181 that illustrates how the biometric values determined for hand 181 from features of a biometric image of the hand's vasculature may be distorted if the 3D spatial coordinates of the features are not used in determining the biometric values. In picture image 121 hand 181 is rotated about an axis 250 in a direction indicated by circle arrow 251 by an angle of about 30° relative to an orientation of hand 181 in biometric picture image 101 shown in FIG. 2B. As a result in the biometric picture image 121 distances indicated by straight lines 204 between blood vessel branching points 202 appear different from distances between the blood vessel branching points in biometric picture image 101. A concentration of blood vessel branching points 202 per unit area of the back of the hand also appears different. Components of straight lines 204 perpendicular to axis 250 are shortened, and concentration of blood vessel branching points 202 is increased in biometric picture image 121 relative to biometric picture image 101. If 3D spatial coordinates for features of vasculature 103 are not used in determining biometric image values they will be different from the biometric image values determined for the same features from 3D biometric hand image 101*.

In the above description, 3D biometric image values were described as extracted from 3D biometric hand images and compared with 3D biometric template values stored in biometric database 54 to find a match between the 3D biometric hand image and a 3D biometric template and an identity for person 18. However, embodiments of the invention are not limited to extracting 3D biometric image values and comparing the extracted values and template values to determine an identity for a person.

For example, in an embodiment of the invention 3D spatial coordinates comprised in a 3D biometric image may be used to determine an orientation and distance of the biometric identifier imaged in the 3D biometric image relative to 3D range camera 30. The distance and orientation may be used to determine an affine transformation that transforms the 3D biometric image to a standard orientation and distance. The standard orientation and distance may be an orientation and distance that characterize biometric picture images stored as 3D biometric templates of the biometric identifier in biometric database 54. 3D biometric template values may comprise values defining features of pixels, such as intensity of pixels in a grayscale IR picture or RGB (Red, Green, Blue) values of pixels in a color picture, in the biometric picture images. To determine a match for the 3D biometric image and an identity for a person from whom the 3D biometric image was acquired, the 3D biometric image is transformed using the affine transformation to the standard orientation and distance. Following transformation, the affine transformed biometric picture image, which may be provided by a 3D range camera system in accordance with an embodiment of the invention, is compared to the template biometric picture images in biometric database 54 to determine a match to the 3D biometric image.

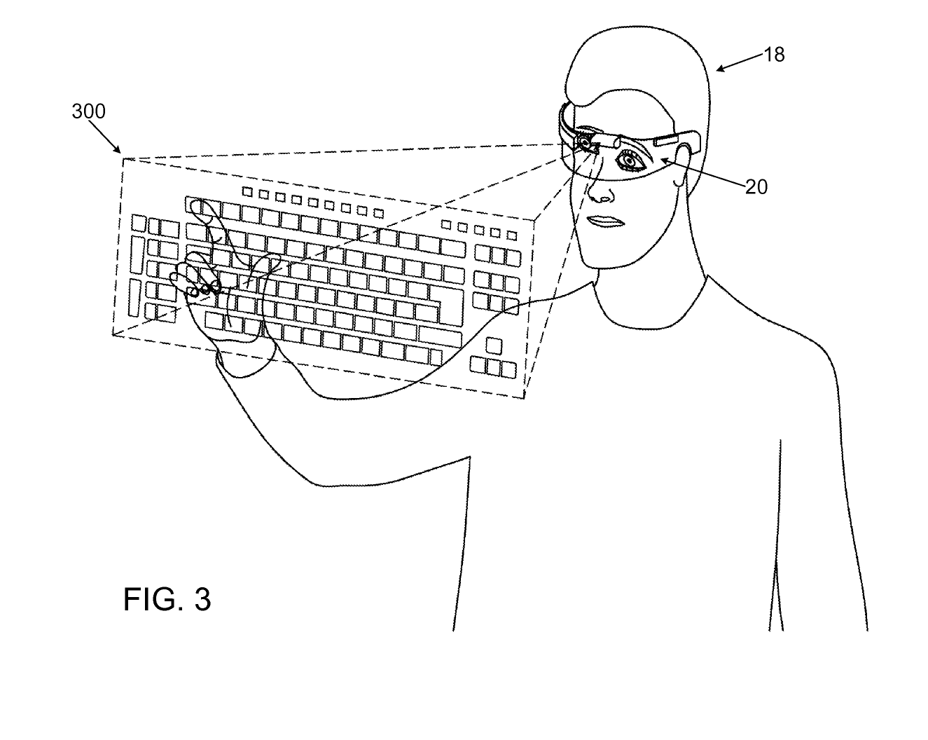

In an embodiment of the invention, if 3D-BIS 20 determines an identity for person 18 and that identity is authorized to access resources that might be made available by or via 3D-BIS 20, the 3D-BIS provides or enables access to the resource. For example, as schematically shown in FIG. 3, after identifying person 18 and authenticating that the person may be granted use of AR system 42, the AR system might provide person 18 with a virtual keyboard 300 and connection to a communication network and optionally the Internet. 3D-BIS 20 may comprise any suitable interface for connecting to the communication network and the Internet, such as at least one, or any combination of a WiFI, a Bluetooth, and/or a cell-phone interface (not shown). Person 18 may use virtual keyboard 300 to communicate for example with Internet sites. Optionally, person 18 may use virtual keyboard 300 to send SMS (Short Message Service) communications or tweets via a cell-phone network. In an embodiment of the invention the 3D-BIS may comprise a SIM (Subscriber Identity Module) or USIM (Universal Subscriber Identity Module) card to facilitate communication with a cell-phone network. Optionally, 3D-BIS 20 provides person 18 with access to computer 50 via virtual keyboard 300 and functionalities provided by the virtual keyboard. Input to virtual keyboard 300 by person 18 may be determined responsive to 3D range images of the hands of person 18 provided by 3D range camera 30. Responses to input on virtual keyboard 300 may be provided on a virtual display screen (not shown) generated by AR system 42.

It is noted that whereas 3D-BIS 20 comprises a 3D range camera 30, an AR system and a computer comprising a database, which are all indicated as mounted to a same head worn device, practice of the invention is not limited to such configurations. For example, a 3D-BIS in accordance with an embodiment of the invention may be a distributed system with components located in different physical venues and communicating with each other via a suitable communication network, such as by way of example, a cell-phone network, LAN (local area network), WLAN (wireless local area network) and/or WAN (wide area network). A 3D-BIS in accordance with an embodiment of the invention may be cloud based. For example, a 3D-BIS in accordance with an embodiment of the invention may comprise only a 3D range camera that is worn by a person. Other components such as the computer and biometric database may be located elsewhere, the computer may be a desktop computer or a cloud server, and the biometric database may reside in a distributed cloud based server system.

Embodiments of the invention are not limited to 3D range cameras that are worn by a person. A 3D-BIS in accordance with an embodiment of the invention may have a 3D range camera mounted to any non-wearable apparatus to acquire 3D range and picture images of a person's hands and authorize use of the apparatus by the person responsive to the images.

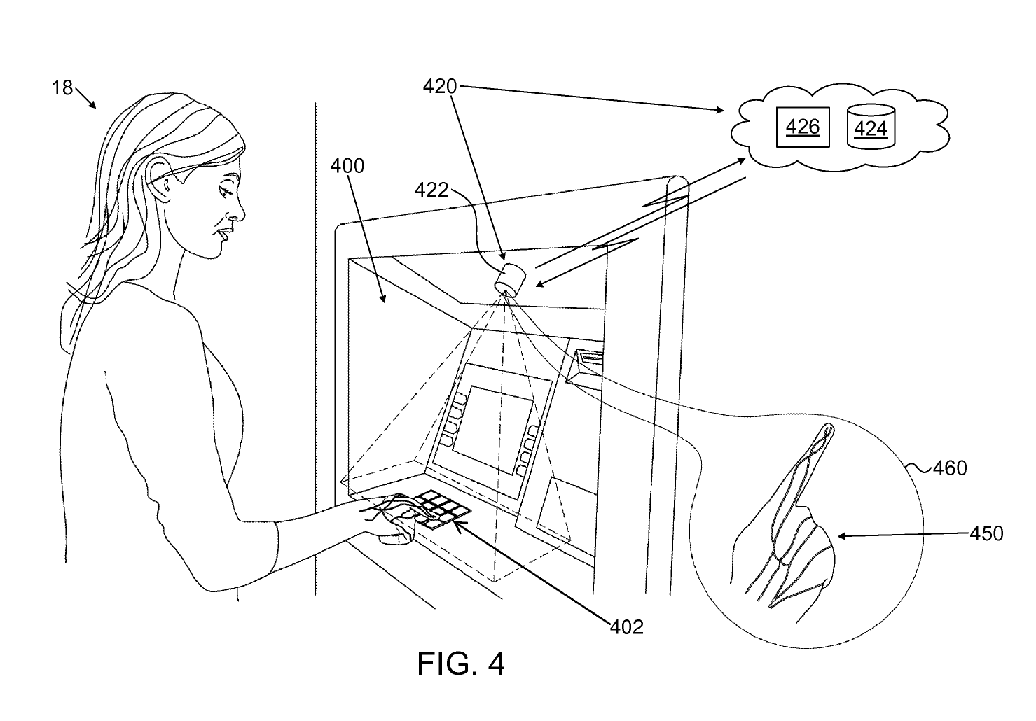

By way of example, FIG. 4 schematically shows a person 18 accessing an ATM (automatic teller machine) 400 that is protected by a 3D-BIS 420 in accordance with an embodiment of the invention. 3D-BIS 420 comprises a 3D-range camera 422 located in ATM 400 to image hands of a person attempting to use ATM 400 and acquire a biometric range image and picture image of a hand of person 18 as the person operates keyboard 402 of ATM 400. A biometric picture image 450 acquired by 3D-BIS 420 of the hand of person 18 operating keyboard 402 is schematically shown in an inset 460. Processing biometric picture image 450 and a corresponding 3D range image of the hand of person 18 to determine an identity for person 18 in accordance with an embodiment of the invention is performed, optionally, by a cloud based processor 426 and cloud based biometric database 424 comprised in 3D-BIS 420.

In an embodiment of the invention, 3D-range camera 422 acquires an image, optionally a 3D biometric image of the face of person 18. Optionally, processor 426 processes the image to determine an identity of person 18 and uses the “biometric face identity” together with the identity determined from the biometric hand image of person 18 to determine an identity of person 18 having enhanced reliability relative to an identity provided by the biometric hand image or face image alone.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A three dimensional biometric identification system (3D-BIS) comprising:
a head worn support;
a 3D range camera mounted to the head worn support and configured to acquire a 3D range image and a picture image of a biometric hand identifier of a person wearing the 3D range camera;
a memory storing a biometric database having a 3D biometric template for the biometric hand identifier for each of at least one enrollee of the 3D-BIS; and
a processor that uses the 3D range image and picture image to provide a 3D biometric image for the biometric hand identifier and determines an identity for the person responsive to the 3D biometric image and the 3D biometric template of an enrollee of the at least one enrollee.

2. The 3D-BIS according to claim 1 wherein the biometric identifier comprises vasculature of a hand of the person.

3. The 3D-BIS according to claim 2 wherein the vasculature comprises dorsal vasculature of the hand.

4. The 3D-BIS according to claim 1 wherein the 3D biometric template comprises 3D biometric template values for the biometric identifier, each comprising a designation of a feature of the biometric identifier or an attribute of the feature, associated with 3D spatial coordinates that define a location of the feature, or an attribute of the biometric identifier derived from a plurality of features of the biometric identifier responsive to their 3D spatial coordinates.

5. The 3D-BIS according to claim 4 wherein to determine an identity for the person the processor extracts a plurality of 3D biometric image values from the 3D biometric image, each value comprising a designation of a feature of the 3D biometric image or an attribute of the feature, associated with 3D spatial coordinates that define a location of the feature in the 3D biometric image, or an attribute of the 3D biometric image derived from a plurality of features of the 3D biometric image responsive to their 3D spatial coordinates.

6. The 3D-BIS according to claim 5 wherein the processor compares 3D image values with 3D template values of the 3D biometric template of the enrollee to determine an identity for the person.

7. The 3D-BIS according to claim 1 wherein the memory is mounted to the head worn support.

8. The 3D-BIS according to claim 1 and comprising apparatus configured to provide the person with a virtual or an augmented reality.

9. The 3D-BIS according to claim 8 wherein the apparatus is configured to provide the person with an interactive display that may be operated by the person's hand gestures.

10. The 3D-BIS according to claim 9 wherein the 3D-range camera provides range and picture images of the hand gestures that the processor processes to recognize the hand gestures and enable the person to interact with the interactive display.

11. The 3D-BIS according to claim 10 wherein the interactive display comprises a virtual keyboard.

12. The 3D-BIS according to claim 8 wherein the processor enables access and use of the apparatus providing virtual or augmented reality subject to the identity determined for the person being an identity of a person authorized for access and use of the apparatus.

13. The 3D-BIS according to claim 1 and comprising a communication interface for connecting the person with a communication network.

14. The 3D-BIS according to claim 13 wherein the communication interface comprises at least one, or any combination of a WiFI, Bluetooth, or cell-phone network interface.

15. A three dimensional biometric identification system (3D-BIS) for preventing unauthorized use of an apparatus, the 3D-BIS comprising:
a 3D range camera mounted to the apparatus and configured to acquire a 3D range image and a picture image of a biometric hand identifier of a person attempting use of the apparatus;
a memory storing a biometric database having a 3D biometric template for the biometric hand identifier for each of at least one authorized user of the apparatus; and
a processor that uses the 3D range image and picture image to provide a 3D biometric image for the biometric hand identifier and determine an identity for the person responsive to the 3D biometric image and the 3D biometric template of a user of the at least one user;
wherein the processor does not provide authorization to use the apparatus if the determined identity is not an identity of a user of the at least one user.

16. The 3D-BIS according to claim 15 wherein the apparatus is an automatic teller machine (ATM).

17. A method of identifying a person, the method comprising:
acquiring a 3D biometric template for the biometric hand identifier for each of at least one person;
acquiring a 3D range image and a picture image of a biometric identifier associated with a hand of a person to be identified;
generating a 3D biometric image of the biometric identifier responsive to the 3D range image and the picture image; and
providing an identity for the person to be identified responsive to the 3D biometric image and a 3D biometric template acquired for a person of the at least one person.

18. The method according to claim 17 wherein the biometric identifier comprises vasculature of a hand of the person.

19. The method according to claim 18 wherein the vasculature comprises dorsal vasculature of the hand.

20. The method according to claim 18 wherein the biometric identifier comprises a feature of the structure of the hand.
